(19) United States
(12) Patent Application Publication
(10) Pub. No.: US 2020/0033928 A1
(43) Pub. Date: Jan. 30, 2020

(54) METHOD OF PERIODICALLY RECORDING FOR EVENTS

(71) Applicants: INVENTEC (PUDONG) TECHNOLOGY CORPORATION, Shanghai City (CN); INVENTEC CORPORATION, Taipei City (TW)

(72) Inventor: Xi-Lang Zhang, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/119,669

(22) Filed: Aug. 31, 2018

(30) Foreign Application Priority Data
Jul. 26, 2018 (CN) 201810832336.2

(51) Int. Cl. G06F 1/30; G06F 1/28; G06F 11/07; G06F 11/00

(52) U.S. Cl. CPC G06F 1/30; G06F 1/28; G06F 2201/805; G06F 11/004; G06F 11/0772; G06F 11/0751

(57) ABSTRACT

A method of periodically recording for events is disclosed. The method includes the following steps: accessing a register of a power supply by a baseboard management controller to obtain a message related to the power supply; confirming a logical sensor status of the power supply according to the message by the baseboard management controller so as to determine whether a predicted failure status of the power supply is detected, and monitoring a predetermined logical variable by the baseboard management controller; generating an event log when the predicted failure status of the power supply is detected by the baseboard management controller; performing a timing task selectively according to a result of monitoring related to the predetermined logical variable by the baseboard management controller so as to determine whether to generate a control command; generating another event log according to the control command by the baseboard management controller.

### CROSS-REFERENCE TO RELATED APPLICATIONS

This non-provisional application claims priority under 35 U.S.C. § 119(a) on Patent Application No(s). 201810832336.2 filed in China on Jul. 26, 2018, the entire contents of which are hereby incorporated by reference.

### TECHNICAL FIELD

The disclosure relates to a method of periodically recording for events, more particularly to a method of periodically recording for events associated with a power supply.

### BACKGROUND

In general, a server is equipped with a baseboard management controller (BMC) adapted to monitor sensor statuses to generate event logs. For example, the baseboard management controller would compare a current sensor status to parameter information stored in a sensor data record (SDR). If the current sensor status matches the parameter information, an event log would be generated.

A PSU predictive failure indicates a warning state configured to remind a user that a power supply is almost failed, so that the user is able to notice this matter and determine whether to replace the power supply. Since the number of event logs which is allowed to be stored in a server is limited, older event logs will be overwritten by new event logs when the number of event logs reaches a maximum number.

When a predictive failure status is detected by a baseboard management controller, an occurrence of an event will be recorded correspondingly. It means that an event log is generated. If a user does not view the event log associated with the failed power supply, the event log will be replaced by other event logs. As a result, a reminder cannot be deliver to the user.

### SUMMARY

A method of periodically recording events is disclosed according to one embodiment of the present disclosure. The method includes the following steps: accessing a register of a power supply by a baseboard management controller to obtain a message related to the power supply; confirming a logical sensor status of the power supply according to the message by the baseboard management controller so as to determine whether a predicted failure status of the power supply is detected, and monitoring a predetermined logical variable by the baseboard management controller; generating an event log when the predicted failure status of the power supply is detected by the baseboard management controller; performing a timing task selectively according to a result of monitoring related to the predetermined logical variable by the baseboard management controller so as to determine whether to generate a control command; and generating another event log according to the control command by the baseboard management controller, wherein the another event log is different from the event log.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a server according to one embodiment of the present disclosure;

FIG. 2 is a flow chart of a method of periodically recording for events according to one embodiment of the present disclosure; and

FIG. 3A and FIG. 3B are a detailed flow chart of a method of periodically recording for events according one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

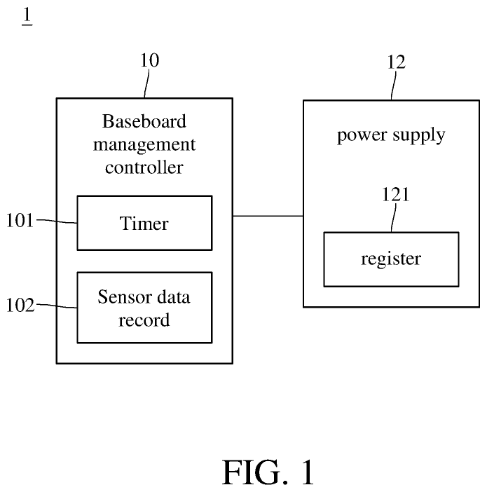

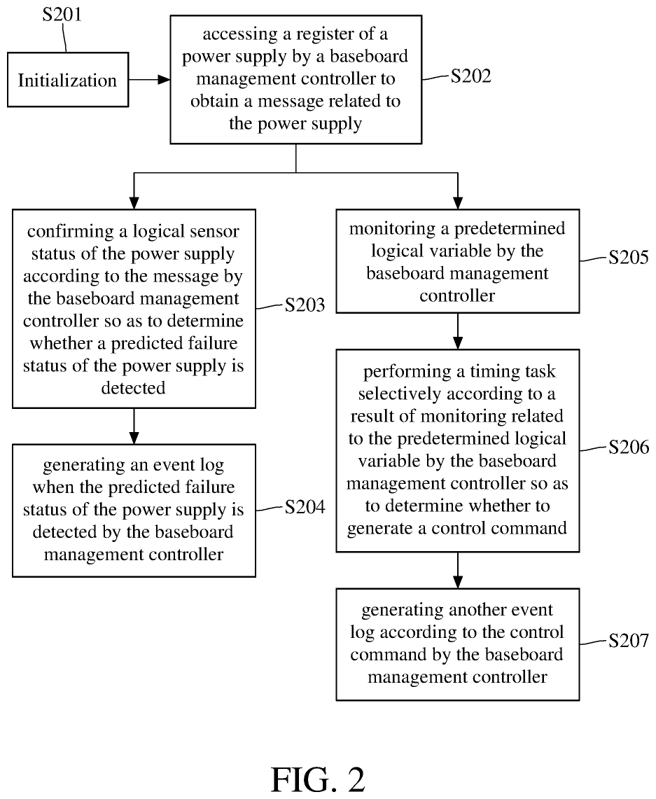

Please refer to FIG. 1 and FIG. 2. FIG. 1 is a block diagram of a server according to one embodiment of the present disclosure, and FIG. 2 is a flow chart of a method of periodically recording for events according to one embodiment of the present disclosure. The method of periodically recording for events shown in FIG. 2 can be implemented by the server shown in FIG. 1. As shown in FIG. 1, a server 1 includes a baseboard management controller (BMC) 10 and a power supply 12. In this embodiment, the baseboard management controller 10 communicates with the power supply 12 via a power management bus (PMbus). In practice, the server 1 includes other basic components such as a processor, a memory, etc. Those basic components are well-known techniques to persons skilled in the art, details related to the basic components are not repeated here.

The method of the present disclosure is disclosed as in FIG. 2, in step S201, the baseboard management controller 10 of the server 1 first performs an initialization process so as to enable a various of functions of the baseboard management controller 10. In step S202, the baseboard management controller 10 accesses a register 121 in the power supply 12 to obtain a message related to the power supply 12. In a practical example, the message includes one of a temperature message, an input/output power consumption message, an input/output voltage message and a status message of the power supply. In practice, the power supply 12 has the register 121 storing a message associated with an operation of the power supply 12, such as the temperature message, the input/output power consumption message, the input/output voltage message and the status message of the power supply as described above. In a real implementation, the baseboard management controller 10 accesses the register 121 of the power supply 12 at intervals (e.g. access per second) so as to obtain the message continuously. In this example, the power supply 12 has a single register only. However, in practice, the power supply 12 has a plurality of registers.

In step S203, the baseboard management controller 10 confirms a logical sensor status of the power supply 12 according to the message so as to determine whether a predicted failure status of the power supply 12 is detected. Specifically, the baseboard management controller 10 confirms the logical sensor status based on the message when obtaining the message stored in the register 121 of the power supply 12, in order to determine whether the predicted failure status occurs within the power supply 12. In step S204, when determining that the predicted failure status of the power supply 12 is detected, the baseboard management controller 10 generates an event log correspondingly. In practice, the baseboard management controller 10 determines that the predicted failure status of the power supply 12 is detected if a bit corresponding to the message is 1. In contrast, the baseboard management controller 10 determines that the predicted failure status of the power supply 12 is not detected if a bit corresponding to the message is 0.

In addition to step S203 described above, the method further includes step S205 to step S207. In step S205, the baseboard management controller 10 monitors a predetermined logical variable. In step S206, the baseboard management controller 10 selectively performs a timing task according to a result of monitoring of the predetermined logical variable, so as to determine whether to generate a control command. If the baseboard management controller 10 determines to generate the control command according to the result of monitoring described as above, the baseboard management controller 10 generates another event log according to the control command as shown in step S207. In this embodiment, the another event log and the aforementioned event log are independent to each other. In the method of the present disclosure, the baseboard management controller 10 is capable of setting the predetermined logical variable to be true according to the predicted failure status. Furthermore, the baseboard management controller 10 determines that it is required to perform the timing task when monitoring that the predetermined logical variable is set to be true. Further, the baseboard management controller 10 determines whether to generate the control command for generating the another event log according to a result of the timing task. Detailed descriptions about operations of the baseboard management controller 10 in the method of the present disclosure will be given in the following paragraphs.

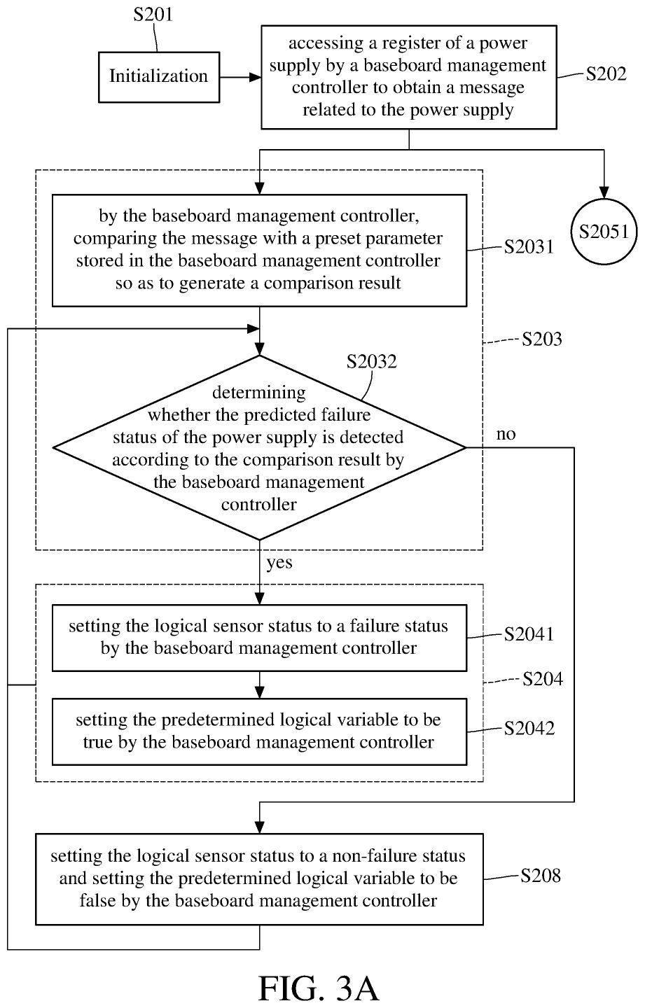

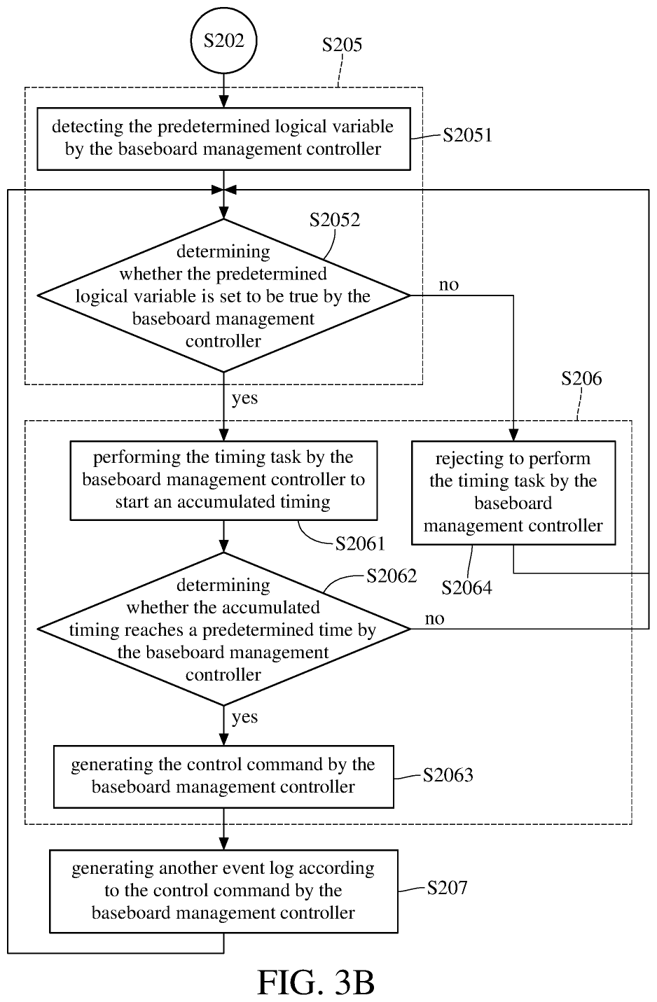

Please refer to FIG. 3A and FIG. 3B, which are a detailed flow chart of a method of periodically recording for events according one embodiment of the present disclosure. As shown in the figures, “confirming the logical sensor status of the power supply 12 according to the message by the baseboard management controller 10 so as to determine whether the predicted failure status of the power supply 12 is detected” shown in step S203 includes steps S2031 and S2032. In step S2031, the baseboard management controller 10 compares the message with a preset parameter stored in the baseboard management controller 10 to generate a comparison result. In step S2032, the baseboard management controller 10 determines whether the predicted failure status of the power supply 12 is detected according to the comparison result. Specifically, the baseboard management controller 10 compares the message obtained from the register 121 to the preset parameter stored in a sensor data record (SDR) 102 of the baseboard management controller 10. If the comparison result indicates that the message matches the preset parameter, the baseboard management controller 10 determines that an occurrence of the predicted failure status of the power supply 12 is detected, so as to generate another event log.

In one embodiment, “the baseboard management controller 10 generates an event log when the predicted failure status of the power supply 12 is detected” shown in step S204 includes steps S2041 and S2042. In step S2041, the baseboard management controller 10 sets the logical sensor status to be a failure status. In step S2042, the baseboard management controller 10 sets the predetermined logical variable to be true. In other words, the baseboard management controller 10 sets the logical sensor status to be a failure status and sets the predetermined logical variable to be true when an occurrence of the predicted failure status of the power supply 12 is detected. Thereby, the another event log described above can be generated. In another embodiment, the method further includes step S208. In step S208, the baseboard management controller 10 sets the logical sensor status to be a non-failure status and sets the predetermined logical variable to be false when the predicted failure status of the power supply 12 is not detected. Then, return to the step of determining whether the predicted failure status of the power supply 12 is detected by the baseboard management controller 10.

In one embodiment, “monitoring the predetermined logical variable by the baseboard management controller 10” shown in step S205 includes steps S2051 and S2052. In step S2051, the baseboard management controller 10 detects the predetermined logical variable. In step S2052, the baseboard management controller 10 determining whether the predetermined logical variable is set to be true. In other words, the baseboard management controller 10 continuously detects the predetermined logical variable during the process of monitoring. When an occurrence of the predicted failure status of the power supply 12 is detected by the baseboard management controller 10, the predetermined logical variable will be set to be true. Meanwhile, by the process of monitoring, the baseboard management controller 10 obtains the information indicating that the predetermined logical variable is set to be true.

In one embodiment, “performing the timing task selectively according to the result of monitoring related to the predetermined logical variable by the baseboard management controller 10 so as to determine whether to generate the control command” shown in step S206 includes steps S2061-S2064. When the baseboard management controller 10 determines that the predetermined logical variable is set to be true, the baseboard management controller 10 performs the timing task so as to start an accumulated timing in step S2061. In step S2062, the baseboard management controller 10 determines whether the accumulated timing reaches a predetermined time. When the accumulated timing started by the baseboard management controller 10 reaches the predetermined time, the baseboard management controller 10 generates the control command in step S2063. In practice, as shown in FIG. 1, the baseboard management controller 10 includes a timer 101 used for performing the timing task. In a practical example illustrating the above steps, when the baseboard management controller 10 determines that the predetermined logical variable is set to be true, it means that the power supply 12 is almost in a status of failure. Accordingly, the baseboard management controller 10 generate an event log, which can be considered as a first event log. Meanwhile, the baseboard management controller 10 enables the timer 101 to counting. For example, the counting of the timer 101 is performed in one increments per second from zero.

If the predetermined time is preset to be 259200 seconds (namely “a period of 3 days”) in the example, the baseboard management controller 10 generates a control command when the counting of the timer 101 is 259200, and further the control command is sent to the baseboard management controller 10 itself via an application programming interface (API). As shown in step S207, the baseboard management controller 10 is capable of generating another control command, which can be considered as a second event log. The second event log and the first event log are independent to each other and generated in different time pints. The predetermined time mentioned in the example is merely for illustration, and the present disclosure is not limited to the predetermined time illustrated in the example. In practice, a user is allowed to select a proper length of a period of the generations related to the event logs according to actual demands.

In other words, in the method of the present disclosure, if the user does not replace the power supply 12 due to the failure of noticing the generation of the first event log, then the accumulated timing of the timer 101 may reach the predetermined time (e.g. a period of 3 days), so that the baseboard management controller 10 generates the second event log according to the control command. The second event log is adapted to warn the user to replace the power supply 12 with a new power supply. By using periodic generations of event logs to remind the user, it can be avoided that the user fails to notice the power supply 12 facing failure status because of an overwriting of the first event log by other types of event logs. In a real implementation, the counting of the timer 101 is reset to be zero and return to the step of determining whether the predetermined logical variable is set to be true after the baseboard management controller 10 generates the second event log. If the user does not replace the power supply 12 with another power supply, then the baseboard management controller 10 will generate a third event log in the next period (namely the accumulated timing reaches the next 259200 second). In contrast, if the user replaces the power supply 12 with another power supply before the accumulated timing of the timer 101 reaches the predetermined time, then the accumulated timing of the timer 101 is stopped and reset to be zero and return to step S2052. In this case, since the occurrence of the predicted failure status disappears and is not detected power supply 12 anymore, the baseboard management controller 10 sets the logical sensor status to be a non-failure status and sets the predetermined logical variable to be false.

In one embodiment, when the baseboard management controller 10 determines that the predetermined logical variable is set to be false, the baseboard management controller 10 will not perform the timing task (the timing of timer 101 is set to be zero) as shown in step S2064 and return to the step of determining whether the predetermined logical variable is set to be true by the baseboard management controller 10. In other words, the setting of “false” of the predetermined logical variable indicates that the power supply 12 is in the non-failure status, so it is not necessary for the timer 101 to start an accumulated timing for generating event logs to remind the user to replace the power supply.

Based on the above descriptions, in the method of periodically recording for events provided by the present disclosure, the baseboard management controller is used for determining whether the predicted failure status of the power supply is detected or not. If detected, the baseboard management controller generates an event log, and further determines whether to generate a next event log by performing the timing task. The baseboard management controller periodically generates the event logs related to the power supply, so that the situation in which the first event log is overwritten by other types of event logs. Thereby, the information indicating the failure of the power supply can be provided for the user repeatedly so that the user would replace the failed power with a new power supply.

What is claimed is:

1. A method of periodically recording for events, comprising:
accessing a register of a power supply by a baseboard management controller to obtain a message related to the power supply;
confirming a logical sensor status of the power supply according to the message by the baseboard management controller so as to determine whether a predicted failure status of the power supply is detected, and monitoring a predetermined logical variable by the baseboard management controller;
generating an event log when the predicted failure status of the power supply is detected by the baseboard management controller;
performing a timing task selectively according to a result of monitoring related to the predetermined logical variable by the baseboard management controller so as to determine whether to generate a control command; and
generating another event log according to the control command by the baseboard management controller, wherein the another event log is different from the event log.

2. The method of periodically recording for events according to claim 1, wherein generating the event log when the predicted failure status of the power supply is detected by the baseboard management controller comprises setting the logical sensor status to a failure status and setting the predetermined logical variable to be true by the baseboard management controller so as to generate the event log.

3. The method of periodically recording for events according to claim 1, wherein monitoring the predetermined logical variable by the baseboard management controller comprises:
detecting the predetermined logical variable by the baseboard management controller; and
determining whether the predetermined logical variable is set to be true by the baseboard management controller.

4. The method of periodically recording for events according to claim 3, wherein performing the timing task selectively according to the result of monitoring related to the predetermined logical variable by the baseboard management controller so as to determine whether to generate the control command comprising:
performing the timing task, by the baseboard management controller, to start an accumulated timing when the baseboard management controller determines that the predetermined logical variable is set to be true; and
generating the control command by the baseboard management controller when the accumulated timing, started by the baseboard management controller, reaches a predetermined time.

5. The method of periodically recording for events according to claim 4, wherein performing the timing task selectively according to the result of monitoring related to the predetermined logical variable by the baseboard management controller so as to determine whether to generate the control command further comprising:
returning to determining whether the predetermined logical variable is set to be true by the baseboard management controller when the accumulated timing, started by the baseboard management controller, does not reach the predetermined time.

6. The method of periodically recording for events according to claim 3, wherein performing the timing task selectively according to the result of monitoring related to the predetermined logical variable by the baseboard management controller so as to determine whether to generate the control command further comprising:
rejecting to perform the timing task by the baseboard management controller and returning to determining whether the predetermined logical variable is set to be true by the baseboard management controller when the baseboard management controller determines that the predetermined logical variable is set to be false.

7. The method of periodically recording for events according to claim 1, further comprising:
setting the logical sensor status to a non-failure status and setting the predetermined logical variable to be false by the baseboard management controller and returning to determining whether the predicted failure status of the power supply is detected when the predicted failure status of the power supply is not detected by the baseboard management controller.

8. The method of periodically recording for events according to claim 1, wherein confirming the logical sensor status of the power supply according to the message by the baseboard management controller so as to determine whether the predicted failure status of the power supply is detected comprising:
by the baseboard management controller, comparing the message with a preset parameter stored in the baseboard management controller so as to generate a comparison result; and
determining whether the predicted failure status of the power supply is detected according to the comparison result by the baseboard management controller.

9. The method of periodically recording for events according to claim 1, wherein the message comprises one of a temperature message, an input/output power consumption message, an input/output voltage message and a status message.
